(19) United States
(12) Patent Application Publication
(10) Pub. No.: US 2019/0347033 A1
(43) Pub. Date: Nov. 14, 2019

(54) APPARATUSES AND METHODS AND COMPUTER PROGRAM PRODUCTS FOR FACILITATING DELETIONS OF FILE DATA THAT IS PROTECTED BY COPY-ON-WRITE SNAPSHOTS

(71) Applicant: Synology Inc., New Taipei City (TW)

(72) Inventors: Ming-Feng WEI, New Taipei City (TW); Po-Chun WU, New Taipei City (TW)

(73) Assignee: Synology Inc., New Taipei City (TW)

(21) Appl. No.: 16/249,403

(22) Filed: Jan. 16, 2019

Related U.S. Application Data
(60) Provisional application No. 62/669,978, filed on May 10, 2018.

(51) Int. Cl. G06F 3/06; G06F 11/14; G06F 16/901; G06F 16/9035

(52) U.S. Cl. CPC G06F 3/0652; G06F 3/0608; G06F 11/1448; G06F 11/1471; G06F 16/9027; G06F 16/9035; G06F 3/0673

(57) ABSTRACT

The invention introduces an apparatus for facilitating deletions of file data that is protected by copy-on-write (COW) snapshots, at least including a storage device and a processing unit. The processing unit calculates release estimates for accumulated inspection sets, each of which includes one or more identities (IDs) of first COW snapshots, deleting second COW snapshots with references made to the release estimates, and deleting the sets of file data that are invisible from a directory tree and are not protected by any COW snapshot after the second COW snapshots are deleted.

### CROSS-REFERENCE TO RELATED APPLICATIONS

This application claims the benefit of priority to U.S. Provisional Application Ser. No. 62/669,978, filed on May 10, 2018; the entirety of which is incorporated herein by reference for all purposes.

### BACKGROUND

The disclosure generally relates to storage systems and, more particularly, to apparatuses and methods and computer program products for facilitating deletions of file data that is protected by snapshots.

It often takes a long time to complete a full backup of a large data set. Moreover, a large amount of storage space is consumed to store the full backups at different moments. To address the storage limitations, a storage system may perform the backup on a snapshot that is a read-only copy of data sets, including subfolders, data files, fragments of data files, or others, captured at a moment and allow applications to continue updating the data sets. In other words, a snapshot is the state of a file folder at a particular moment. Each snapshot may have the same data sets of the file folder as that of some others and unique data sets from the others. In modern systems each data set may be referred by the file system or one or more snapshots through pointers. Any data set that is referred by the file system or one copy-on-write (COW) snapshot cannot be deleted from the storage system until all references to the data set are removed. Only deleting snapshots rather than data sets can effectively release enough space. However, estimating actual space that can be released in response to deletions of the snapshots is difficult due to the complicated inter-references between the data sets and the snapshots. Thus, it is desirable to have apparatuses and methods and computer program products for facilitating deletions of file data that is protected by COW snapshots.

### SUMMARY

In view of the foregoing, it may be appreciated that a substantial need exists for methods, computer program products and apparatuses that mitigate or reduce the problems above.

In an aspect of the invention, the invention introduces an apparatus for facilitating deletions of file data that is protected by copy-on-write (COW) snapshots, at least including a storage device and a processing unit. The storage device stores sets of file data in a subvolume, where each set of file data is associated with one of objects of a directory tree, and each object refers to one or more first COW snapshots. The processing unit calculates release estimates for accumulated inspection sets, each of which includes one or more identities (IDs) of second COW snapshots; deletes third COW snapshots with references made to the release estimates; and deletes the sets of file data that are invisible from a directory tree and are not protected by any COW snapshot after the third COW snapshots are deleted.

In another aspect of the invention, the invention introduces a non-transitory computer program product for facilitating deletions of file data that is protected by COW snapshots, when being executed by a processing unit coupled to the storage device, the computer program product at least including program code to: calculate release estimates for accumulated inspection sets, each of which includes one or more identities (IDs) of second COW snapshots; delete third COW snapshots with references made to the release estimates; and delete the sets of file data that are invisible from the directory tree and are not protected by any COW snapshot after the third COW snapshots are deleted.

In still another aspect of the invention, the invention introduces an apparatus for facilitating deletions of file data that is protected by COW snapshots, at least including a display unit and a processing unit. The processing unit directs the display unit to display a first graphical user interface (GUI) comprising a first button; sends a first request with filter criteria to request a file system to calculate release estimates for accumulated inspection sets, each of which includes one or more IDs of first COW snapshots that have met the filter criteria when the first button is clicked; receives the release estimates from the file system; directs the display unit to display a second GUI comprising a second button and an estimation graph plotting a curve showing the release estimates; and sends a second request to the file system to delete second COW snapshots with references made to the release estimates and delete sets of file data that are invisible from a directory tree and are not protected by any COW snapshot after the second COW snapshots are deleted.

Both the foregoing general description and the following detailed description are examples and explanatory only, and are not restrictive of the invention as claimed.

### BRIEF DESCRIPTION OF THE DRAWINGS

FIG. 1 is the system architecture of a storage system according to an embodiment of the invention.

FIG. 2 is the software architecture of a snapshot management system according to an embodiment of the invention.

FIG. 3 shows a data structure of an exemplary data block.

FIGS. 4 to 6 illustrate exemplary file data accesses and snapshot creations within a subvolume.

FIG. 7 is an estimation graph showing the results of release estimates in MB for each COW snapshot according to some implementations.

FIGS. 8 and 14 show estimation windows according to embodiments of the invention.

FIG. 9 is an estimation graph showing the results of accumulated estimates in GB that can be released since a specified start date according to an embodiment of the invention.

FIG. 10 is a flowchart illustrating a method for calculating release estimates for a set of COW snapshots, performed by a snapshot estimator when being loaded and executed by a processing unit, according to an embodiment of the invention.

FIG. 11 is a flowchart illustrating a method for deleting COW snapshots and all objects and their associated data that can be removed and are not protected by any COW snapshot, performed by a file system when being loaded and executed by a processing unit, according to an embodiment of the invention.

FIG. 12 is a flowchart illustrating a method for automatically deleting the COW snapshots, performed by a snapshot management application or a automatic snapshot cleaner when being loaded and executed by a processing unit, according to an embodiment of the invention.

FIG. 13 shows a sequence diagram illustrating message exchanges between a client and a storage server according to an embodiment of the invention.

FIG. 15 is a flowchart illustrating a method for providing a cached final result of release estimates according to an embodiment of the invention.

### DETAILED DESCRIPTION

Reference is made in detail to embodiments of the invention, which are illustrated in the accompanying drawings. The same reference numbers may be used throughout the drawings to refer to the same or like parts, components, or operations.

The present invention will be described with respect to particular embodiments and with reference to certain drawings, but the invention is not limited thereto and is only limited by the claims. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

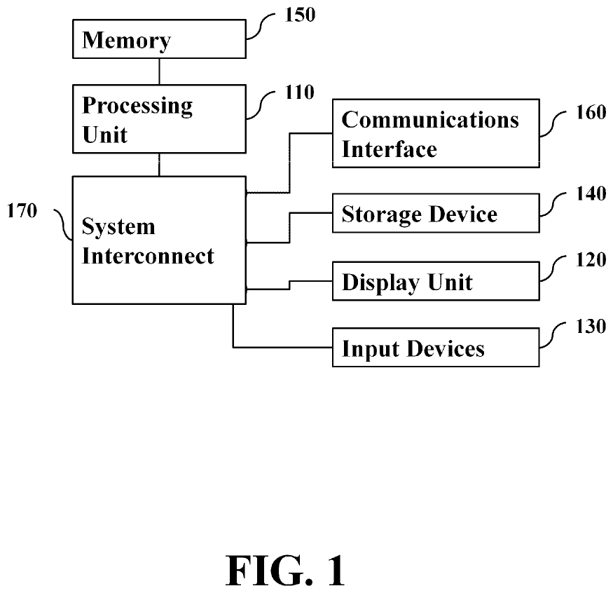

Embodiments of a storage system may be practiced in a file server, a network attached storage (NAS) server or others. One or more clients may connect to the storage system via networks including a local area network (LAN), a wireless telephony network, the Internet, a personal area network (PAN) or any combination thereof. FIG. 1 is the system architecture of a storage system according to an embodiment of the invention. The processing unit 110 may be implemented in numerous ways, such as with dedicated hardware, or with general-purpose hardware (e.g., a single processor, multiple processors or graphics processing units capable of parallel computations, or others) that is programmed using microcode or software instructions to perform the functions recited herein. The processing unit 110 may contain at least an arithmetic logic unit (ALU) and a bit shifter. The ALU is multifunctional device that can perform both arithmetic and logic function. The ALU is responsible for performing arithmetic operations, such as add, subtraction, multiplication, division, or others, Boolean operations, such as AND, OR, NOT, NAND, NOR, XOR, XNOR, or others, and mathematical special functions, such as trigonometric functions, a square, a cube, a power of n, a square root, a cube root, a n-th root, or others. Typically, a mode selector input decides whether ALU performs a logic operation or an arithmetic operation. In each mode different functions may be chosen by appropriately activating a set of selection inputs. The bit shifter is responsible for performing bitwise shifting operations and bitwise rotations. The system architecture further includes a memory 150 for storing necessary data in execution, such as variables, data tables, data abstracts, a wide range of indices, or others. The memory 150 may be a random access memory (RAM) of a particular type that provides volatile storage space. The processing unit 110 may connect to a communications interface 160, a storage device 140, a display unit 120 and one or more input devices 130 via a system interconnect 170. The storage device 140 may be practiced to include one or more hard disk (HD) drives, one of more solid state disk (SSD) drives, or others, to provide non-volatile storage space for storing program codes, such as an operating system (OS), system kernels, drivers, software applications, and user data files. The HD or SSD drives may be organized as a redundant array of independent disks (RAID) group. The communications interface 160 may be included in the system architecture and the processing unit 110 can thereby communicate with the other electronic equipment. The communications interface 160 may be a local area network (LAN) module, a wireless local area network (WLAN) module, a Bluetooth module, a 2G/3G/4G/5G telephony communications module or any combinations thereof. In an embodiment. the system architecture may include the input devices 130 to receive user input, such as a keyboard, a mouse, a touch panel, or others. A user may press hard keys on the keyboard to input characters, control a mouse pointer on a display by operating the mouse, or control an executed application with one or more gestures made on the touch panel. The gestures include, but are not limited to, a single-click, a double-click, a single-finger drag, and a multiple finger drag. The display unit 120, such as a Thin Film Transistor Liquid-Crystal Display (TFT-LCD) panel, an Organic Light-Emitting Diode (OLED) panel, or others, may also be included to display input letters, alphanumeric characters and symbols, dragged paths, drawings, or screens provided by an application for the user to view. In another embodiment, the input device 130 and the display unit 120 may be optional. For example, in a network-based storage system (such as NAS), the storage system may receive the commands via various network protocols, including but not limited to: Apple Filing Protocol (AFP), Server Message Block (SMB), File Transfer Protocol (FTP), Network File System (NFS), Hypertext Transfer Protocol (HTTP), Hypertext Transfer Protocol (HTTPS), etc. In such embodiments, the network-based storage system can be managed by one or more remote devices through Internet, and therefore, the input device 130 and the display unit 120 are not necessary. The system architecture as shown in FIG. 1 may be practiced in a client, such as a personal computer (PC), a laptop computer, a mobile phone, a tablet computer, etc., with relevant modifications.

The storage device 140 may include one or more hard disks (HDs), solid state disks (SSDs) or the both, or other types of non-volatile storage drives, for storing sets of file data. Each set of file data may be stored in a subvolume and associated with one of plurality of objects of a directory tree. The storage device 140 may further store information about one or more COW snapshots that each object refers to.

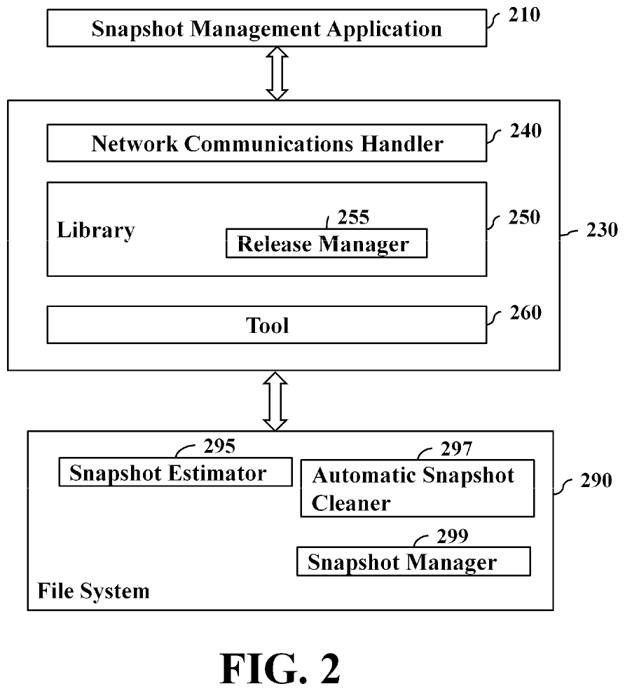

FIG. 2 is the software architecture of a snapshot management system according to an embodiment of the invention. The snapshot management system may be divided into layers, such as a snapshot management application 210, a middleware 230 and a file system 290. Each of the layers may specify the shared communications protocols and interface methods used by its upper layer. The middleware 230 may include a network communications handler 240, a library 250 and a tool 260. The file system 290 may include a snapshot estimator 295 and an automatic snapshot cleaner 297. Each of the aforementioned modules is composed of software instructions, macrocodes, microcodes, or others, that can be loaded and executed by the processing unit 110 with relevant data abstracts. The aforementioned modules may be run in a multitasking environment with a single processor or in parallel executions of different tasks with multiple processor cores. The memory 150 may be separated by an operating system (OS) into kernel space and user space. The kernel space may be reserved for running an OS kernel, kernel extensions, and device drivers. The OS kernel may include a file system 290. The user space may refer to all code that runs outside of the OS kernel, kernel extensions, and device drivers. The user space may occupy certain portions of the memory 150 where a snapshot management application 210 and a middleware 230. It is to be understood that the snapshot management application 210 may be run on a processing unit of a client when loading and executing relevant software and/or firmware instructions, and communicate with the middleware 230 through the networks using various communications protocols over Internet Protocol (IP) and the invention should not be limited thereto. The middleware 230 may include a network communications handler 240, a library 250 and a tool 260. Each user space process typically runs in its own virtual memory space, and, unless explicitly allowed, cannot access the memory of other processes.

The file system 290 may be a b-tree file system (Btrfs) based on the copy-on-write (COW) mechanism. In another embodiments, the file system 290 may be ZFS, reiserFS, Ubifs file systems that support COW mechanism. In yet another embodiments, if the file systems perform COW snapshots, then the file systems may be able to implement the claimed invention described in the present disclosure. It should be understood that the specific file systems mentioned in the present disclosure is for exemplary purposes only and should not be construed as limiting of the scope of the present disclosure.

In an embodiment, the file system 290 may have a default subvolume and the default subvolume may be changed as required. Any other subvolume may be accessed by mounting the default subvolume, in which are visible and accessible as its subdirectories. Subvolumes may be created at any place within the file system hierarchy, and nested. Nested subvolumes appear as subdirectories within their parent subvolumes. A directory tree may include user-visible files and directories. There is one directory tree per subvolume. Within the directory tree, each object may have an object identifier (ID), which is assigned dynamically on creation, and an Mode item describing that is a file or a directory. The Mode item may further store the attributes and physical location(s) of the object's data. The object attributes may include metadata, such as times of last change, access, modification, a length of file data, or others, as well as a status, an owner and a permission list. Within each directory object, directory entries appear as directory items. In addition to the Mode item, each of the file and directory objects may have a reference item recording the object ID of its parent object.

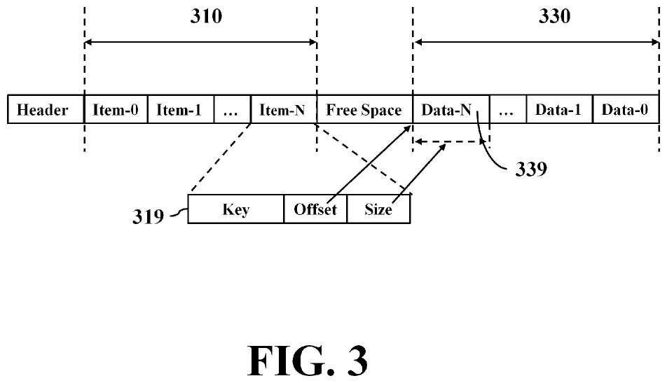

File data is maintained outside the directory trees in file extents (also referred to as data blocks), which are contiguous runs of physical blocks. Each file object may have an extent item to track which data block holds its file data. FIG. 3 shows a data structure of an exemplary data block. Each data block of the directory tree may be divided into two sections 310 and 330 that grow toward each other. The data block may have an array 310 of fixed-size items denoted as Item-0 to -N, and an area 330 where item data denoted as Data-0 to -N is stored. The offset and size fields of the item 319 may indicate where in the data block the item data 339 can be found. Small files that occupy less than one data block may be packed into the extent item. Larger files may be stored in several data blocks.

The file system 290 may provide a snapshot-take operation that is automatically triggered every preset time period or is manually triggered through a man-machine interface (MMI) provided by the snapshot management application 210, and atomically creates a snapshot for each of predetermined subvolumes. The snapshot (hereinafter referred to as the COW snapshot) may be considered as another subvolume that shares its data (and metadata) with a corresponding subvolume using the COW capabilities. Each cloned object may store one or more reference links to indicate which snapshots are referred to. It is advantageous to store reference links in each object to efficiently estimate release potentials while traversals of the directory tree.

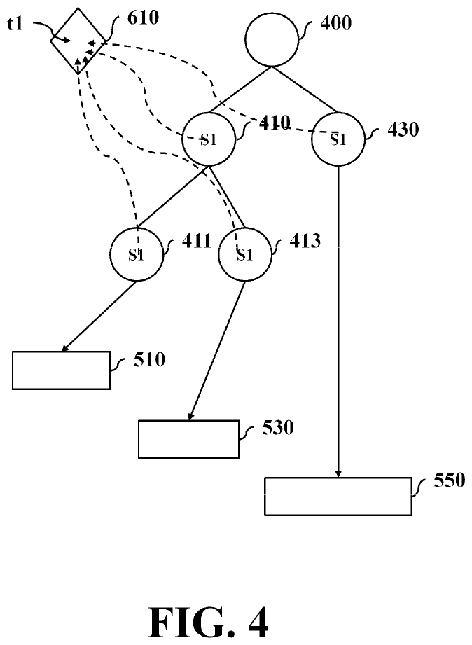

Several use cases for creating snapshots are provided. FIGS. 4 to 6 illustrate exemplary file data accesses and snapshot creations within a subvolume. Initially, the object 400 is a root node of a subvolume “/home” and has two child objects: a directory object 410 and a file object 430. The directory object 410 has two child file objects 411 and 413. The data blocks 510, 530 and 550 store file data of the file objects 411, 413 and 430, respectively. Suppose that the sizes of the file data of the file objects 411, 413 and 430 are 3M, 5M and 10M bytes, respectively.

Refer to FIG. 4. At moment t1, a COW snapshot 610 is created with an object ID “S1”. The object ID “S1” may be stored in the objects 410, 411, 413 and 430 as a reference link. The status of the Mode item of each object may be initially set to “Normal” (may be referred to as a normal object).

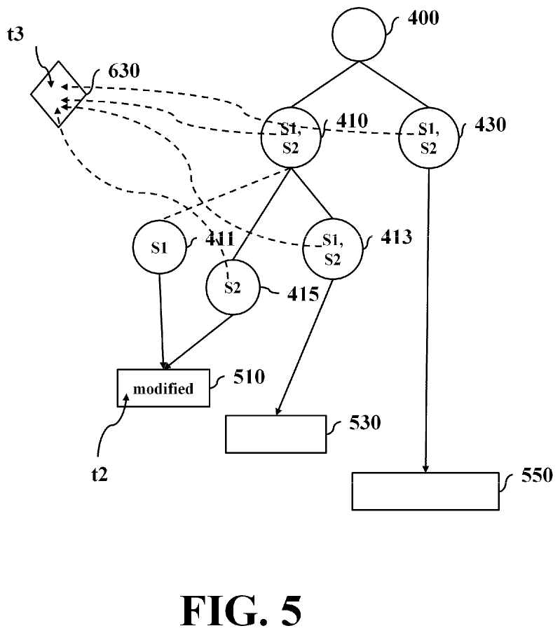

Refer to FIG. 5. At moment t2, the file data of the file object 411 is modified using the COW. Note that the original file data of the file object 411 cannot be removed from the data block 510 because it is presented in (or protected by) the snapshot 610. Suppose that the size of the modified file data is 3M bytes. To reflect the modification, the reference item of the file object 411 is removed, so that the file object 411 is invisible from the directory tree of the subvolume “/home”. The connection between the directory object 410 and the file object 411 becomes a dash line. The status of the Mode item of the file object 411 may be changed to “Modified” (may be referred to as a modified object). A new object 415 is created with a reference item recording the object ID of the directory object 410 and an inode item indicating a physical location of the leaf object 510 where the modified file data is stored, so that the file object 415 is mounted to the directory tree. The status of the Mode item of the file object 415 may be initially set to “Normal”. Note that the original and modified file data occupies different areas of the leaf object 510. At moment t3, a COW snapshot 630 is created with an object ID “S2”. The object ID “S2” may be stored in the object 415 as a reference link. Moreover, the object ID “S2” may be appended to the reference items of the objects 410, 413 and 430 as a reference link.

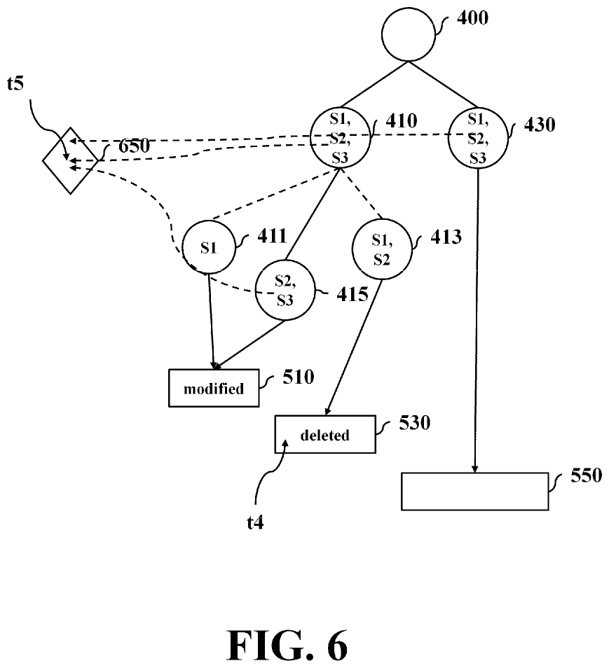

Refer to FIG. 6. At moment t4, the file data of the file object 413 is deleted from the data block 530 using the COW. Note that the file data of the file object 413 cannot be removed from the data block 530 because it is presented in the snapshots 610 and 630. To reflect the deletion, the reference item of the file object 413 is removed, so that the file object 413 is invisible from the directory tree. The connection between the directory object 410 and the file object 413 becomes a dash line. The status of the Mode item of the file object 413 may be changed to “Deleted” (may be referred to as a deleted object). At moment t5, a COW snapshot 650 is created with an object ID “S3”. The object ID “S3” may be appended to the reference items of the objects 410, 415 and 430 as a reference link.

Although FIGS. 4 to 6 describe reference links recorded in the reference items of the objects, those artisans, for each snapshot, may alternatively use an array, a linked list, a data table to record object IDs of the covered objects, and the invention should not be limited thereto. For example, an array stores the object IDs of the objects 410, 411, 413 and 430 that are associated with the snapshot 610, an array stores object IDs of the objects 410, 413, 415 and 430 that are associated with the snapshot 630 and an array stores object IDs of the objects 410, 415 and 430 that are associated with the snapshot 650.

Once snapshots are made, they can be treated as alternative versions of the original directory tree. The file data within the directory tree may be damaged, for example, encrypted by a notorious ransomware cryptoworm. To roll back to one snapshot, the encrypted original subvolume needs to be unmounted and the snapshot is mounted in its place. As previously discussed, creating snapshots is important to achieve better protection of file data. Unfortunately, the COW snapshots occupy excessive space of the storage device 140 because the space of the deleted file data is not released until no snapshot covers the deleted file data. The storage system needs to balance the benefits from data security versus the cost of storing COW snapshots. It may require information about an estimation of released space before certain COW snapshots are deleted. However, it is complicated to estimate storage space that can be released when the amount of COW snapshots is huge.

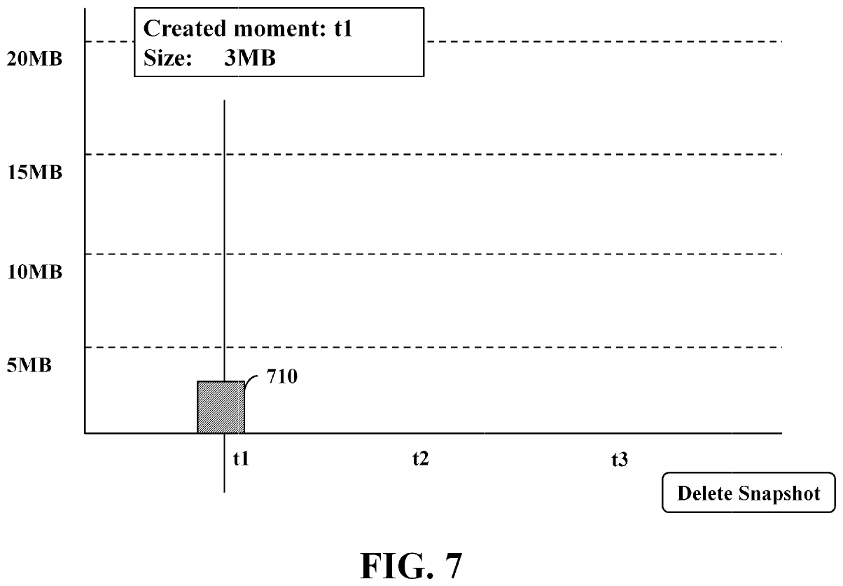

In some implementations, a snapshot management system may provide algorithms in a middleware or a file system kernel for a release estimate for each COW snapshot. The algorithms may derive from release potential estimations of typical full-image snapshots rather than COW snapshots. The full-image snapshots are treated as independent from each other. With references made to the use cases as shown in FIG. 6, while the file data of each of the file objects 413, 415 and 430 is protected by at least the COW snapshot 630 or 650, only the file data of the file object 411 can be removed and 3 MB of storage space is estimated to be released when the COW snapshot 610 is deleted. OMB of storage space is estimated to be released when the COW snapshot 630 is deleted while the file data of each of the file objects 411, 413, 415 and 430 is protected by at least the COW snapshot 610 or 650. Similarly, 0 MB of storage space is estimated to be released when the COW snapshot 650 is deleted. Moreover, a user interface is provided for displaying release estimates for COW snapshots individually that are calculated by the algorithms. FIG. 7 is an estimation graph showing the results of release estimates in MB for each COW snapshot according to some implementations. Only one bar 710 is presented in the bar chart to indicate that 3 MB of storage space can be released when the COW snapshot 610 is deleted. However, the information displayed in the bar chart may mislead a user into deleting the COW snapshot 610 only. In fact, the file data of the file objects 411 and 413 can be removed and 8 MB of storage space can be released when the COW snapshots 610 and 630 are deleted. The file data of the file objects 411, 413, 415 and 430 and the directory data of the directory object 410 can be removed and 21 MB of storage space can be released when the COW snapshots 610, 630 and 650 are deleted. The biases are happened when the release potentials are estimated for individual COW snapshots and the aforementioned estimation algorithms may be improper to apply to the COW snapshots.

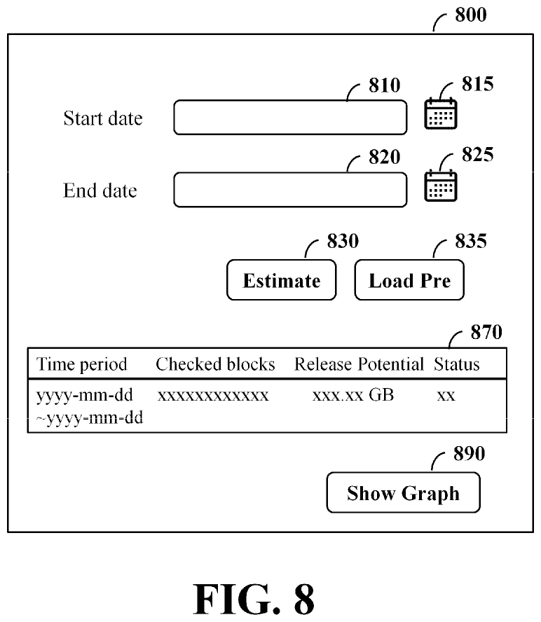

Refer to FIG. 2. To address the aforementioned problems, the snapshot management application 210 may provide a human-machine interface (MMI) to help a user to select a time period for calculating release estimates during which the COW snapshots are pseudo-deleted. Note that the pseudo deletion does not delete any file or directory data physically but only takes the selected COW snapshots not into account in estimations. The snapshot management application 210 may direct the display unit 120 to display a graphical user interface (GUI). FIG. 8 shows an estimation window according to an embodiment of the invention. Since the COW snapshots are many, a user usually intends to delete COW snapshots within a specified time period. Two input boxes 810 and 820 may be provided in an estimation window 800 to make a user to key in a start date and an end date of a desired time period, respectively. Two calendar icons 815 and 825 may be provided alongside with the input boxes 710 and 720. When any of the calendar icons 815 and 825 is clicked, a graphical calendar appears, by which a user can select a date as a start or as an end date. The selected date is displayed in a respective input box. After the start and end dates are inputted a button 830 captioned with “Estimate” may be clicked to request the snapshot management application 210 for calculating release estimates during the determined time period. The snapshot management application 210 may send an estimation request with the determined time period in the JavaScript Object Notation (JSON) format to the middleware 230 to request for an estimation operation. Although embodiments of the invention describe a click event of the button 830 to trigger a calculation of release estimates, those artisans may alternatively trigger that after an event of any user interface (UI) control has occurred, for example, a menu item is selected, a radio box is clicked, an item of a drop box is selected, or others. The following shows an exemplary JSON representation describing an estimation request:
{“api”:“SYNO.Snap.Usage.Share”,“method”:“start”,“version”:1,“share_name”:“test”,“range”:{“range_start”:1524672000,“range_end”:1525276799}}
   The value “start” of the attribute “method” is used to instruct the middleware 230 to start an estimation operation. The value “test” of the attribute “share_name” may indicate a share folder name identifying a designated share folder. The value “15246720000” of the attribute “range_start” may indicate a start date and the value “1525276799” of the attribute “range_end” may indicate an end date.

The snapshot management application 210 may receive a response indicating a triggering success of the estimation operation from the middleware 230. The following shows an exemplary JSON representation describing a response:
[{“api”:“SYNO.Snap.Usage.Share”,“method”:“start”,“success”: true,“version”: 1}], “success”:true}
   The true value of the attribute “success” indicates that the estimation operation has been started successfully.

After the estimation operation has started, the snapshot management application 210 may periodically request the middleware 230 to report the current estimation progress. The snapshot management application 210 may receive a response from the middleware 230 that includes information about a size amount of the objects that have been scanned (i.e. the current scan progress) and the maximum amount of the scanned objects that can be released. Each time the response has been received the snapshot management application 210 may update the content of the message box 870 accordingly. The following shows an exemplary JSON representation describing the current estimation progress:
{“data”:{“share_list”:[{“estimated_in_bytes”:8192,“processed_in_bytes”:21504,“range_end”:1525276799,“range_start”:1524672000},“share_name”:“test”,“status”:“done”}]}
   The value “test” of the attribute “share_name” may indicate a share folder name identifying a designated share folder. The value “done” of the attribute “status” indicates that the estimation operation is successfully ongoing. The value of the attribute “processed_in_bytes” indicates that 21504 bytes have been scanned and the value of the attribute “estimated_in_bytes” indicates that about 8192 bytes of the scanned objects can be released.

Since the estimation may take a long time, the snapshot management application 210 may actively request the middleware 230 to report release estimates that have been calculated so far. Alternatively, the middleware 230 may continuously and actively report estimated sizes that can be released accumulation by accumulation to the snapshot management application 210 through the responses until the snapshot management application 210 requests to stop the estimation operation. Two or more accumulated estimations may be reported in one response.

The snapshot management application 210 may receive a response from the middleware 230 that includes information about an accumulated size that can be released if certain COW snapshots are pseudo-deleted. The following shows an exemplary JSON representation describing estimation results in combination with the current estimation progress:
{“data”:{“end_task”:1525250057,“estimated_in_bytes”:8192,“processed_in_bytes”:21504,“range_end”:1525276799,“range_start”:1524672000,“snap_list”:[{“accum_usage”:8192,“subvol_id”:404,“time”:“GMT+08-2017.05.02-15.06.39”},{“accum_usage”:8192,“subvol_id”:405,“time”:“GMT+08-2017.05.02-16.07.44?}],“start_task”:1525250057,“status”:“done”},“success”:true}
   A collection “snap_list” includes two release estimations. The first one shows that about 8192 bytes can be released if all from the first COW snapshot of the start date (i.e. the beginning COW snapshot) to the COW snapshot with a subvolume (i.e. snapshot) ID “404”, which is created at 15:06:39 on May 2, 2017 (carried by the attribute “time”), in time are pseudo-deleted. The second one shows that about 8192 bytes can be released if all from the beginning COW snapshot to the COW snapshot with a subvolume ID “405”, which is created at 16:07:44 on May 2, 2017, in time are pseudo-deleted.

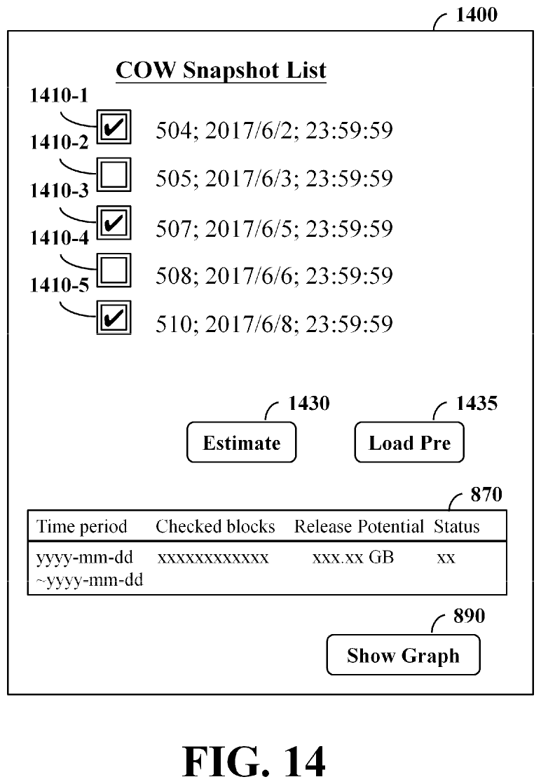

In alternative embodiments, the snapshot management application 210 may provide an MMI to help a user to select designated ones from all or a portion of the COW snapshots for calculating release estimates, which are pseudo-deleted. FIG. 14 shows an estimation window according to an embodiment of the invention. Different from that as shown in FIG. 8, several checkboxes 1410-1 to 1410-5 are provided in an estimation window 1400 and each checkbox is related to one COW snapshot. For example, the checkbox 1410-1 is related to the COW snapshot with the ID “504”, which was created at 23:59:59 on Jun. 2, 2017, the checkbox 1410-2 is related to the COW snapshot with the ID “505”, which was created at 23:59:59 on Jun. 3, 2017, and so on. A user may click a checkbox to select or unselect the related COW snapshot. For example, the COW snapshots with the IDs “504”, “507” and “510” are selected. Then, a button 1430 captioned with “Estimate” may be clicked to request the snapshot management application 210 for calculating release estimates for the selected COW snapshots. The estimation window 1400 provide a feasible way to make a user select discontinuous COW snapshots in release estimations. With the modified estimation window 1400, an exemplary estimation request may be provided as follows:
{“api”:“SYNO.Snap.Usage.Share”,“method”:“start”,“version”:1,“share_name”:“test”, “select_list”:[{“subvol_id1”:504,“subvol_id2”:507,“subvol_id3”:510}]}
   The estimation request encloses a collection “select_list” including COW snapshot IDs “504”, “507” and “510” instead. The determined time period and the selected COW snapshots may be considered as filter criteria for reducing estimation scope.

It is also feasible for the requests and responses to be formatted in something other than the JSON format, for example, eXtensible Markup Language (XML), eXtensible Stylesheet Language (XSL), or others. Although the embodiments have been described having specific attributes, such as the start date, the end date, the scanned bytes, the accumulated size estimation, the last COW snapshot of the snapshot collection, or others, noted that these may be exemplary features, and the invention is equally applicable to systems, methods and computer software products having similar but different attribute values or ranges.

The snapshot management application 210 may collect the estimated sizes of the reports and store them in the memory 150. Table 1 provides exemplary logs of the memory 150 or the storage device 140 that are generated according to the collected content of the reports.

TABLE 1

| | Subvolume (COW | Accumulated GB |
|---|---|---|
| Time period | Snapshot) ID range | that can be released |
| 2017 Jan. 13~2017 Jan. 13 | 300-303 | 0.2 |
| 2017 Jan. 13~2017 Jan. 14 | 300-305 | 0.23 |
| 2017 Jan. 13~2017 Jan. 15 | 300-307 | 0.25 |
| 2017 Jan. 13~2017 Jan. 16 | 300-310 | 0.25 |
| 2017 Jan. 13~2017 Jan. 17 | 300-313 | 0.28 |
| 2017 Jan. 13~2017 Jan. 18 | 300-315 | 0.3 |

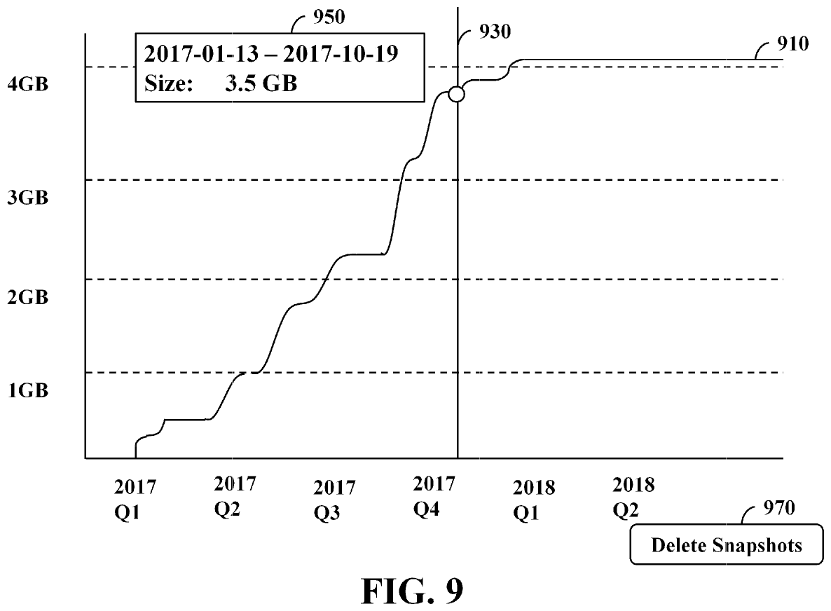

A button 890 captioned with “Show Graph” may be provided below the message box 870. Once the button 890 is clicked an estimation graph is generated according to the collected content and is displayed on the display unit 120. The snapshot management application 210 may direct the display unit 120 to display the estimation graph by using a service of a display driver. FIG. 9 is an estimation graph showing the results of accumulated estimates in GB that can be released since a specified start date according to an embodiment of the invention. The curve 910 may be plotted according to the estimated sizes of the reports and indicate how many GB can be released when all the COW snapshots generated from Jan. 13, 2017 to later moments in time are pseudo-deleted. A message box 950 may display detailed information about an accumulated size that can be released for a specified time period. A vertical line 930 may be moved leftward or rightward by a user to change the end date to display, so that the content of a message box 950 is changed accordingly. For example, when the horizontal line 930 is moved to Oct. 19, 2017 the message box 850 shows that 3.5 GB can be released when all the COW snapshots generated from Jan. 13, 2017 to Oct. 19, 2017 are pseudo-deleted. The message box 950 may show further information, such as an amount of the COW snapshots within the time period, etc. Since a greater COW snapshot ID indicates that the identified COW snapshot is generated later than that with a smaller COW snapshot ID, those artisans may modify the x-axis of the estimation graph with finer scales, for example, by COW snapshot IDs and the invention should not be limited thereto.

Although embodiments of the invention describe that the snapshot management application 210, the middleware 230 and the file system 290 are run by the same processing unit 110, those artisans may devise the software deployment to install the snapshot management application 210 in a remote client rather than being bundled with the middleware 230 and the file system 290. The snapshot management application 210 may send the commands through a remote procedure call (RPC), or others. In alternative embodiments that the snapshot management application 210 is run on a client, the estimation window as shown in FIG. 8 and the estimation graph as shown in FIG. 9 are displayed on a display unit of the client.

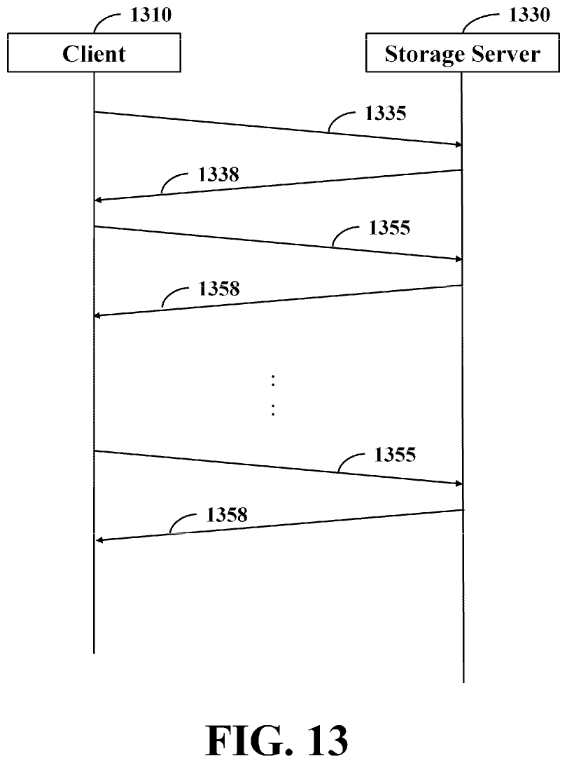

Since the overall system is configured to have a client running the snapshot management application 210 and a storage server running the middleware 230 and the file system 290 with their processing units when loading and executing relevant firmware and/or software instructions, FIG. 13 shows a sequence diagram illustrating message exchanges between a client and a storage server according to an embodiment of the invention. After a calculation of release estimates has been triggered through an MMI of a client 1310, the client 1310 may transmit an estimation request 1335 with filter criteria for a share folder, such as the determined time period, the selected COW snapshot IDs, etc., to a storage server 1330 for requesting the storage server 1330 to start an estimation operation. After the estimation operation successfully starts, the storage server 1330 may respond to the client 1310 with a triggering success message 1338. After that, the client 1310 may periodically issue reporting requests 1355 for reporting current estimation progress and receive reporting responses 1358 indicating the current estimation progress and the updated estimation details until a reception of a reporting response 1358 indicating that the estimation operation has completed.

Refer to FIG. 2. When a request sent to the middleware 230 (may be pushed into a message queue) a snapshot-take event may be dispatched. The middleware 230 may include a network communications handler 240 for periodically listening to the snapshot-take event. Once a snapshot-take event has been dispatched the network communication handler 240 may parse the request and comprehend what kind of the request that the snapshot management application 210 has issued and the attribute values carried in the request. The value of the attribute “method” indicates the request type, for example, a starting of an estimation operation, a reporting of the current estimation progress, a reporting of release estimates, or others. A release manager 255 may be implemented in a library 250, which is an extensible program-code-template for creating objects, providing initial values for the estimation operation, and implementations of behavior, such as functions, methods, etc. The release manager 255 may be a program patch that is obtained from a non-volatile storage medium, such as a DVD, CD-ROM, USB stick, a hard disk, a Blu-ray disc, or from Internet and becomes part of the library 250. The middleware 230 may store information indicating when a COW snapshot was created in the memory 150. Table 2 provides exemplary records of the memory 150 or the storage device 140 that stores profile information of the COW snapshots.

TABLE 2

| Subvolume (COW Snapshot) ID | Created date | Created time |
|---|---|---|
| 404 | 2017 May 2 | 15:06:39 |
| 405 | 2017 May 2 | 16:07:44 |
| 406 | 2017 May 3 | 17:08:50 |

When detecting a request for starting an estimation operation the network communications handler 240 may create an object of the release manager 255 and use a relevant method of the created object with the requested time period. The release manager 255 may search the profile information of the COW snapshots of the memory 150 to find which COW snapshots fall within the requested time period and accordingly issue a command to the tool 260 for obtaining a size that can be released when certain COW snapshots are pseudo-deleted. The following shows an exemplary command for obtaining release potentials of the COW snapshots:

/sbin/btrfs subvolume size −vpm −r/home 404 405 406

The command may advise the tool 260 to execute a Btrfs binary tool with parameters of the subvolume “/home” and the COW snapshots IDs “404”, “405” and “406”. The function “subvolume” of the middleware 230 when being executed may make a system call ioctl( ) to request for a service of a snapshot estimator 295 of the file system 290. For example, the subvolume ID “404” may be associated with the COW snapshot 610 of FIG. 4, the subvolume ID “405” may be associated with the COW snapshot 630 of FIG. 5 and the subvolume ID “406” may be associated with the COW snapshot 650 of FIG. 6.

The snapshot estimator 295 may be a program patch that is obtained from a non-volatile storage medium, such as a DVD, CD-ROM, USB stick, a hard disk, a Blu-ray disc, or from Internet and becomes part of the file system 290. After receiving the estimation results from the snapshot estimator 295 the service routine “subvolume” of the tool 260 returns the received results to the created object of the release manager 255. The release manager 255 may store the results in the memory 150. The following shows an exemplary representation describing estimation results:
{“test”:“snap_list”:{{“GMT+08-2017.05.02-15.06.39”:“404-3072”,“GMT+08-2017.05.02-16.07.44”:“405-8192”},“task_id”:“dc8364e1-6be5-4a2f-82e9-ba35560cd451”,“time”:1525248489,“volume_id”:1}}
   The estimation results may include attribute-value pairs, which are delimited by commas The estimation results show that 3072 bytes can be released if the COW snapshot with the ID “404” is pseudo-deleted, 8192 bytes can be released if the COW snapshots with the IDs “404” and “405” are pseudo-deleted and 21504 bytes can be released if the COW snapshots with the IDs “404”, “405” and “406” are pseudo-deleted.

After receiving the current estimation progress from the snapshot estimator 295 the tool 260 may inform of the received progress to the created object of the release manager 255. The release manager 255 may store the current estimation progress in the memory 150. The following shows an exemplary representation describing the current estimation progress:
{“end_time”:“2018.05.02-18.07.22”,“error_code”:“0”,“estimated_in_bytes”:8192,“pid”:“15242”,“processed_in_bytes”:“21504”,“range_end”:“2017.05.02-23.59.59”,“range_start”:“2017.05.02-00.00.00”,“start_time”:“2018.05.02-16.08.10”,“status”:“done”}
   The current estimation progress may include attribute-value pairs, which are delimited by commas. The current progress shows that 21504 bytes have been scanned and about 8192 bytes of the scanned objects can be released in response to a request for calculating release estimates from 00:00:00 on Apr. 26, 2018 to 23:59:59 on May 2, 2018.

The snapshot management application 210, the middleware 230 and the file system 290 when being loaded and executed in coordination by one or more processing units may calculate release estimates for accumulated inspection sets, each of which includes one or more COW snapshot IDs, delete all or some COW snapshots with references made to the release estimates, and delete the sets of file data that are invisible from the directory tree and are not protected by any COW snapshot after the COW snapshots are deleted. Any of the accumulated inspection sets, except for the first one, includes COW snapshot IDs more than or consistent with that of the prior one. For example, the first accumulated inspection set includes the COW snapshot ID “404”, the second accumulated inspection set includes the COW snapshot ID “404”, the third accumulated inspection set includes the COW snapshot IDs “404”, “405” and “406”, and so on.

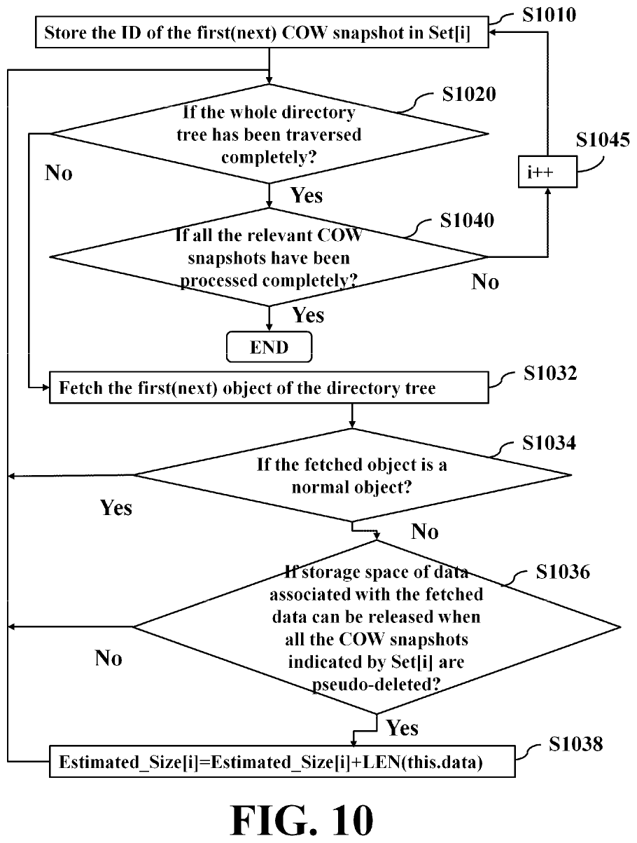

FIG. 10 is a flowchart illustrating a method for calculating release estimates for a set of COW snapshots, performed by the snapshot estimator 295 when being loaded and executed by the processing unit 110, according to an embodiment of the invention. The snapshot estimator 295 may maintain an array Set[ ] and each entry thereof may store one ID associated with a COW snapshot. Moreover, the snapshot estimator 295 may maintain an array Estimated_Size[ ] and each entry thereof may store a release estimate when the corresponding COW snapshot or snapshots are pseudo-deleted. Note that the two arrays may be combined into one two-dimensional array or may be implemented in alternative data abstracts, such as linked lists, data records, data tables, etc. and the invention should not be limited thereto. The estimation operation may begin to set a variable i to 0. An outer loop (including steps S1010, S1040 and S1045) is repeatedly executed until all the COW snapshots within the requested time period have been processed completely (the “Yes” path of step S1040). In each iteration of the outer loop, the variable i is incremented by one except for the first iteration (step S1045) and the ID of the first(next) COW snapshot is stored in Set[i] (step S1010). Moreover, in each iteration of the outer loop, an inner loop (including steps S1020, S1032 to S1038) is repeatedly executed until the whole directory tree has been traversed completely (the “Yes” path of step S1020). Note that the traversed objects not only include the normal objects but also unnormal objects, such as modified, deleted objects, etc. In each iteration of the inner loop, the first or next object of the directory tree is fetched to process (step S1032). The traversal to a b-tree is well-known in the art and is omitted for brevity. The size of the data associated with the fetched object denoted as LEN(this.data) is added to the value of Estimated_Size[i] (step S1038) when the fetched object is not a normal object (“the “No” path of step S1034) and storage space of data associated with the fetched data can be released when all the COW snapshots indicated by Set[i] are pseudo-deleted (the “Yes” path of step S1036). In step S1034, the snapshot estimator 295 may examine the status of the Mode item of the fetched object to determine whether the fetched object is a normal object. In step S1036, the snapshot estimator 295 may examine the reference links of the fetched object to determine whether storage space of data associated with the fetched data can be released when all the COW snapshots indicated by Set[0] to Set[i] are pseudo-deleted. Specifically, the snapshot estimator 295 may remove all the IDs of Set[0] to Set[i] from the reference links of the fetched object and determine whether any reference link remains in the reference links of the fetched object. If so, the snapshot estimator 295 determines that storage space of data associated with the fetched object cannot be released when all the COW snapshots indicated by Set[i] are pseudo-deleted. Otherwise, the snapshot estimator 295 determines the opposite.

A use case accompanying with the COW snapshots 610, 630 and 650 as shown in FIGS. 4 to 6 is introduced to explain how the process of FIG. 10 operates. Suppose that the snapshot estimator 295 receives the IDs “404”, “405” and “406” associated with the COW snapshots 610, 630 and 650 from the return values of the system call iotcl( ).

In the first iteration of the outer loop, the ID “404” is stored in Set[0] (step S1010). After all the inner loops have been executed completely, the snapshot estimator 295 determines that only file data associated with the file object 411 can be pseudo-deleted and sets Estimated_Size[0] to 3096 (bytes). Estimated_Size[0] may be returned (or replied) to the tool 260 with the subvolume ID “404”.

In the second iteration of the outer loop, the ID “405” is stored in Set[1] (step S1010). After all the inner loops have been executed completely, the snapshot estimator 295 determines that file data associated with the file objects 411 and 413 can be pseudo-deleted and sets Estimated_Size[0] to 8192 (bytes). Estimated_Size[1] may be returned to the tool 260 with the subvolume ID “405”.

In the third iteration of the outer loop, the ID “406” is stored in Set[2] (step S1010). After all the inner loops have been executed completely, the snapshot estimator 295 determines that file data associated with the file objects 411, 413, 415 and 430 and directory data associated with the directory object 410 can be pseudo-deleted and sets Estimated_Size[2] to 21504 (bytes). Estimated_Size[2] may be returned to the tool 260 with the subvolume ID “406”.

Refer to FIG. 9. A button 970 captioned with “Delete Snapshots” may be provided near the estimation graph. Once the button 970 is clicked the snapshot management application 210 may send a deletion request to the middleware 230 to delete all COW snapshots from the start date to the date that the vertical line 930 stays for a particular subvolume. In other words, the vertical line 930 defines the last COW snapshot to be deleted when the button 970 is clicked. Although embodiments of the invention describe a click event of the button 970 to trigger a deletion of COW snapshots, those artisans may alternatively trigger that after an event of any UI control has occurred, for example, a menu item is selected, a radio box is clicked, an item of a drop box is selected, or others. A storage estimation layout as shown in FIG. 9 is presented to display at least one accumulated estimation, for example at least one plot of the curve 910, and each accumulated estimation includes a first storage release value (in bytes) of a storage device of a storage system that can be released when corresponding one or more COW snapshots of the storage device are pseudo-deleted. An input indicating a deletion of one or more COW snapshots may be received by a processing unit of a client when a user manipulates a location on the storage estimation layout, for example, clicking the button 970. In response to the input, a request may be made by processing unit of the client to the middleware 230 run on the storage system, and later, a response including a second storage release value (in bytes) of the storage device of the storage system that is actually released may be received from the middleware 230. The second storage release value may be further presented on the storage estimation layout. It is to be understood that the first and second storage release values are greater than zero and may be the same or different.

The middleware 230 may search the profile information of the COW snapshots of the memory 150 or the storage device 140 to find which COW snapshots fall within the requested time period and accordingly make a system call ioctl( ) to request the file system 290 with relevant COW snapshot IDs and subvolume ID for deleting the found COW snapshots and all the objects and the associated data that can be released for the subvolume.

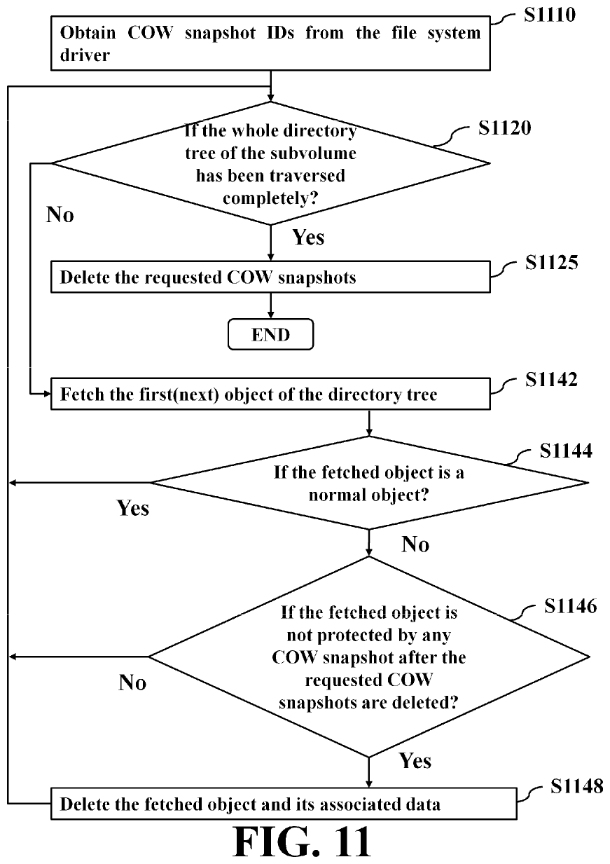

FIG. 11 is a flowchart illustrating a method for deleting COW snapshots and all objects and their associated data that can be removed and are not protected by any COW snapshot, performed by the file system 290 when being loaded and executed by the processing unit 110, according to an embodiment of the invention. After COW snapshot IDs carried in a request are obtained from the middleware 230 a loop (including steps S1120, S1142 to S1148) is repeatedly executed until the whole directory tree of a specific subvolume has been traversed completely (the “Yes” path of step S1120). After the whole directory tree of the subvolume has been traversed completely (the “Yes” path of step S1120) the file system 290 deletes the requested COW snapshots (step S1125). In alternative embodiments, the deletion of the requested COW snapshots may be performed in the beginning of the process. In each iteration of the loop, the first or next object of the directory tree is fetched to process (step S1142). The traversal to a b-tree is well-known in the art and is omitted for brevity. The fetched object and its associated data is deleted when the fetched object is not a normal object (“the “No” path of step S1144) and the fetched object is not protected by any COW snapshot after the request COW snapshots are deleted (the “Yes” path of step S1146). In step S1144, the file system 290 may examine the status of the Mode item of the fetched object to determine whether the fetched object is a normal object. In step S1146, the file system 290 may examine the reference links of the fetched object to determine whether the fetched object is not protected by any COW snapshot after the requested COW snapshots are deleted. Specifically, the file system 290 may remove all the obtained COW snapshot IDs from the reference links of the fetched object and determine whether any reference link remains in the reference links of the fetched object. If so, the file system 290 determines that the fetched data is still protected by one or more COW snapshots after the requested COW snapshots are deleted. Otherwise, the file system 290 determines the opposite.

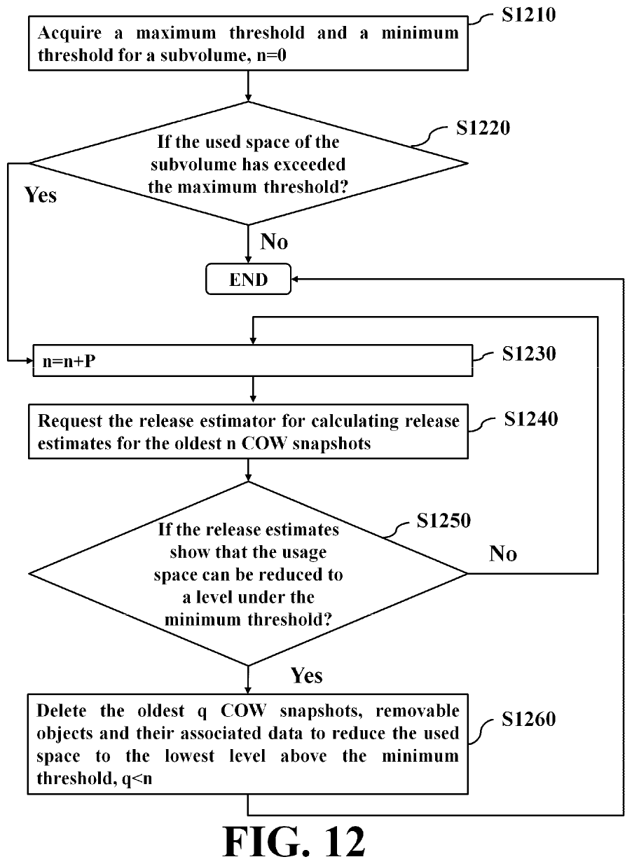

In addition to the manual deletions described in the passages of FIGS. 8-11, embodiments of the invention introduce an automatic process performed by the snapshot management application 210 or the automatic snapshot cleaner 297 to delete the COW snapshots with references made to the release estimates of the accumulated inspection sets. The automatic snapshot cleaner 297 may be a program patch that is obtained from a non-volatile storage medium, such as a DVD, CD-ROM, USB stick, a hard disk, a Blu-ray disc, or from Internet and becomes part of the file system 290. FIG. 12 is a flowchart illustrating a method for automatically deleting the COW snapshots, performed by the snapshot management application 210 or the automatic snapshot cleaner 297 when being loaded and executed by the processing unit 110, according to an embodiment of the invention. The process may be periodically performed with a preset time period. It may configure a maximum threshold and a minimum threshold for a subvolume in advance. For example, the maximum threshold is set to the 90% of the allocated space of the subvolume and the minimum threshold is set to 70% thereof to make a compromise between the data security and the storage capacity. The process may delete certain COW snapshots and the sets of file data to reduce used space of the subvolume to a level between the maximum and minimum thresholds with references made to the release estimates when the used space of the subvolume has exceeded the maximum threshold, which are invisible from the directory tree and are not protected by any COW snapshot after the COW snapshots are deleted. Specifically, the process may begin with an acquisition of the maximum and minimum thresholds and a setting of n=0 (step S1210). When the used space of the subvolume has exceeded the maximum threshold (the “Yes” path of step S1220) a loop (including steps S1230 to S1250) is repeatedly executed to calculate release estimates until the release estimates show that a preset condition has satisfied (the “Yes” path of step S1250). In each iteration of the loop, n is increased by P, where P may be a predefined integer (step S1230) and the release estimator 295 is requested for calculating release estimates for the oldest n COW snapshots (step S1240). Detailed calculations of the release estimates for the oldest n COW snapshots may refer to the descriptions of FIG. 10. Then, the automatic snapshot cleaner 297 determines whether the release estimates show that the used space can be reduced to a level under the minimum threshold (step S1250). If so, the oldest q COW snapshots, removable objects and their associated data are deleted to reduce the used space to the lowest level above the minimum threshold, where q<n (step S1260). Detailed deletions of the oldest q COW snapshots, removable objects and their associated data may refer to the descriptions of FIG. 11. An example is provided as follows: Suppose that the maximum and minimum thresholds for the subvolume are set to 100 MB and 85 MB, respectively, the used space of the subvolume is 101 MB, and the oldest three COW snapshot IDs are “404”, “405” and “406”. The release estimates of three accumulated inspection sets calculated by the snapshot estimator 295 are 3 MB, 8 MB and 21 MB, respectively. The release estimates show that the used space can be reduced to 80 MB (i.e. a level under 85 MB) (the “Yes” path of step S1250) and the oldest two COW snapshots, removable objects and their associated data are deleted to reduce the used space to 93 MB (i.e. the lowest level above the 85 MB) (step S1260).

Since the system architecture is configured to include a client-side processing unit executing the snapshot management application 210 and a server-side processing unit executing the middleware 230 and the file system 290 and the client-side and server-side processing units communicate with each other through their communications interfaces. The server-side processing unit may receive network packets carrying an estimation request from a client through a server-side communications interface, which requests to estimate how much space can be released when one or more COW snapshots are pseudo-deleted and includes information about a share folder, a time period and a release estimation command To respond to the estimation request, the server-side processing unit may calculate release estimations for accumulated inspection sets, each of which includes the COW snapshots within the time period for the share folder, and direct the server-side communications interface to transmit network packets carrying the release estimations to the client as a reply.

The calculations of release estimates for designated COW snapshots may consume excessive time and computation resources. The snapshot estimator 295 may store a final result of specified release estimates, such as the arrays Set[ ] and Estimated_Size[ ] as described with FIG. 10, or others, for a share folder in the storage device 140 and the final result may be reused if a client requests to calculate the same release estimates or a portion of the same ones in the future. For example, the snapshot estimator 295 may store the calculated release estimates in response to a request issued by a client for calculating release estimates for the COW snapshots with IDs “504”, “507” and “510”. Five days later, the snapshot estimator 295 may directly reply with the stored final result in response to the same request for calculating release estimates for the COW snapshots with IDs “504”, “507” and “510” without further calculations. In an embodiment, the estimation window 800 as shown in FIG. 8 may further provide a button 835 captioned with “Load Pre” that is initially disabled. When an estimation time period has been set with the input boxes 810 and 820 the snapshot management application 210 may request the middleware 230 and in turn the middleware 230 may request the snapshot estimator 295 whether a final result for the estimation time period has been calculated before. The button 835 is enabled when the snapshot management application 210 receives a reply that a final result for the estimation time period has been calculated. In an alternative embodiment, the estimation window 1400 may further provide a button captioned with “Load Pre” that is initial disabled. When certain COW snapshots have been set with the checkboxes 1410-1 to 1410-5 the snapshot management application 210 may request the middleware 230 and in turn the middleware 230 may request the snapshot estimator 295 whether a final result for the selected COW snapshots has been calculated before. The button 1435 is enabled when the snapshot management application 210 receives a reply that a final result for the selected COW snapshots has been calculated. When the button 835 or 1435 is clicked by a user the snapshot management application 210 may request the middleware 230 and in turn the middleware 230 may request the snapshot estimator 295 to get the previously cached final result of release estimates for the share folder, enabling the estimation graph corresponding to the cached final result to be shown. However, certain snapshot-intervening operations, such as subvolume clones, snapshot restores, etc., performed by the snapshot manager 299 when being loaded and executed by the processing unit 110 may make the stored final result distorted because the protections of the objects of the share folder have been altered. A subvolume clone may be performed to clone an existing directory tree or a portion of underlying objects to a new subvolume. A snapshot restore may be performed to get back a snapshot as the current directory tree for a share folder. The stored final result may become no or less informative if the distorted extent is not tolerable.

To monitor whether the stored final results of release estimates are informative, the snapshot manager 299 may maintain information to reflect the distorted extent of the stored final result for a particular share folder since the last calculations of the release estimates for the share folder. In an embodiment, the snapshot manager 299 may increase an operated-number by one, which indicates how many times the snapshot-intervening operations have been performed for a particular share folder since the last calculations of the release estimates, after or during a snapshot-affected operation for the share folder is performed. In an alternative embodiment, the snapshot manager 299 may add newly affected quantity of files to an affected-file number, which indicates how many files have been affected since the last calculations of the release estimates, during a snapshot-intervening operation for the share folder is performed. In still another embodiment, the snapshot manager 299 may add newly affected size of the share folder to an affected-size number, which indicates how many bytes have been affected since the last calculations of the release estimates, during a snapshot-intervening operation for the share folder is performed.

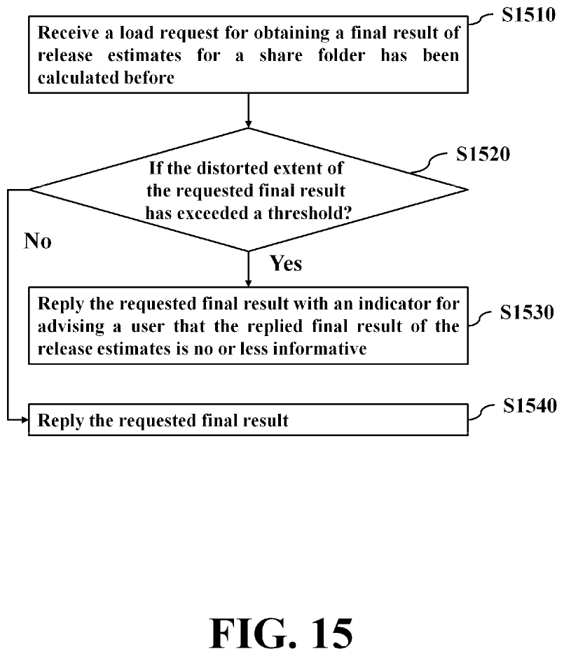

The snapshot estimator 295 may provide a mechanism for warning a user when the final result of release estimates for a share folder has become no or less informative. FIG. 15 is a flowchart illustrating a method for providing a cached final result of release estimates according to an embodiment of the invention. When receiving a load request initiated by the snapshot management application 210 for obtaining a final result of release estimates for a share folder that has been calculated before (step S1510) the snapshot estimator 295 may determine whether the distorted extent of the requested final result has exceeded a threshold, for example, whether the operated-number, the affected-file number, the affected-size number has exceeded a tolerable number (step S1520). If so (the “Yes” path of step S1520), the snapshot estimator 295 may reply to the snapshot management application 210 with the requested final result with an indicator for advising a user that the replied final result of the release estimates is no or less informative (step S1530). The snapshot management application 210 may further display a warning message indicating that the accumulated estimates (i.e. the cached final result) is no or less informative alongside the accumulated estimates as shown in FIG. 9 to advise a user to recalculate the accumulated estimates. Otherwise (the “No” path of step S1520), the snapshot estimator 295 may reply to the snapshot management application 210 with the requested final result without any warning indicator (step S1540).

Some or all of the aforementioned embodiments of the method of the invention may be implemented in a computer program such as an operating system for a computer, a driver for a dedicated hardware of a computer, or a software application program. Other types of programs may also be suitable, as previously explained. Since the implementation of the various embodiments of the present invention into a computer program can be achieved by the skilled person using his routine skills, such an implementation will not be discussed for reasons of brevity. The computer program implementing some or more embodiments of the method of the present invention may be stored on a suitable computer-readable data carrier such as a DVD, CD-ROM, USB stick, a hard disk, a Blu-ray disc, which may be located in a network server accessible via a network such as the Internet, or any other suitable carrier.

The computer program may be advantageously stored on computation equipment, such as a computer, a notebook computer, a tablet PC, a mobile phone, a digital camera, a consumer electronic equipment, or others, such that the user of the computation equipment benefits from the aforementioned embodiments of methods implemented by the computer program when running on the computation equipment. Such the computation equipment may be connected to peripheral devices for registering user actions such as a computer mouse, a keyboard, a touch-sensitive screen or pad and so on.

Although the embodiment has been described as having specific elements in FIG. 1, it should be noted that additional elements may be included to achieve better performance without departing from the spirit of the invention. Each element of FIG. 1 is composed of various circuits and arranged to operably perform the aforementioned operations. While the process flows described in FIGS. 10 to 12 and 15 include a number of operations that appear to occur in a specific order, it should be apparent that these processes can include more or fewer operations, which can be executed serially or in parallel (e.g., using parallel processors or a multi-threading environment).

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An apparatus for facilitating deletions of file data that is protected by copy-on-write (COW) snapshots, comprising:
a storage device arranged to operably store a plurality of sets of file data in a subvolume, wherein each set of file data is associated with one of a plurality of objects of a directory tree, and each object refers to one or more first COW snapshots; and
a processing unit, coupled to the storage device, arranged to operably calculate release estimates for accumulated inspection sets, wherein each of the accumulated inspection sets comprises one or more identities (IDs) of second COW snapshots; delete third COW snapshots with references made to the release estimates; and delete the sets of file data that are invisible from the directory tree and are not protected by any COW snapshot after the third COW snapshots are deleted.

2. The apparatus of claim 1, wherein each object has one or more reference links to indicate which first COW snapshots are referred to.

3. The apparatus of claim 1, wherein a processing unit of a client is arranged to operably display a graphical user interface (GUI) comprising an estimation graph plotting a curve showing the release estimates on a display unit of the client, wherein the GUI comprises a vertical line that is movable and the vertical line defines the last one of the third COW snapshots, the deletions of the third COW snapshots and the sets of file data are performed after an event of a user interface (UI) control has occurred.

4. The apparatus of claim 1, wherein the processing unit is arranged to operably delete the third COW snapshots and the sets of file data to reduce used space of the subvolume to a level between a maximum threshold and a minimum threshold with references made to the release estimates when the used space of the subvolume has exceeded the maximum threshold.

5. The apparatus of claim 1, wherein any of the accumulated inspection sets, except for the first one, includes the second COW snapshot IDs more than or consistent with that of the prior one.

6. A non-transitory computer program product for facilitating deletions of file data that is protected by copy-on-write (COW) snapshots when executed by a processing unit coupled to a storage device storing a plurality of sets of file data in a subvolume, wherein each set of file data is associated with one of a plurality of objects of a directory tree, and each object refers to one or more first COW snapshots, the computer program product comprising program code to:
calculate release estimates for accumulated inspection sets, wherein each of the accumulated inspection sets comprises one or more identities (IDs) of second COW snapshots;
delete third COW snapshots with references made to the release estimates; and
delete the sets of file data that are invisible from the directory tree and are not protected by any COW snapshot after the third COW snapshots are deleted.

7. The non-transitory computer program product of claim 6, comprising program code to: delete the third COW snapshots and the sets of file data to reduce used space of the subvolume to a level between a maximum threshold and a minimum threshold with references made to the release estimates when the used space of the subvolume has exceeded the maximum threshold.

8. The non-transitory computer program product of claim 6, wherein any of the accumulated inspection sets, except for the first one, includes the second COW snapshot IDs more than or consistent with that of the prior one.

9. An apparatus for facilitating deletions of file data that is protected by copy-on-write (COW) snapshots, comprising:
a display unit; and
a processing unit arranged to operably direct the display unit to display a first graphical user interface (GUI) comprising a first user interface (UI) control; send a first request with filter criteria to request a file system when a first event of the first UI control has occurred, so as to calculate release estimates for accumulated inspection sets, wherein each of the accumulated inspections sets comprises one or more identities (IDs) of first COW snapshots that have met the filter criteria; receive the release estimates from the file system; direct the display unit to display a second GUI comprising a second UI control and an estimation graph plotting a curve showing the release estimates; and send a second request to the file system when an event of the second UI control has occurred, so as to delete second COW snapshots with references made to the release estimates and delete a plurality of sets of file data that are invisible from a directory tree and are not protected by any COW snapshot after the second COW snapshots are deleted.

10. The apparatus of claim 9, wherein the first request comprises a first attribute value indicating a start date and a second attribute value indicating an end date as the filter criteria.

11. The apparatus of claim 10, wherein each release estimate is received with the last one of the first COW snapshot IDs of one corresponding accumulated inspection set.

12. The apparatus of claim 9, wherein the first request comprises a collection of COW snapshot IDs that are selected through the first GUI as the filter criteria.

13. The apparatus of claim 9, wherein the sets of file data is stored in a subvolume of a storage device, each set of file data is associated with one of a plurality of objects of the directory tree, and each object refers to one or more third COW snapshots.

14. The apparatus of claim 9, wherein the second GUI comprises a vertical line that is movable and the vertical line defines the last one of the second COW snapshots.

15. The apparatus of claim 9, wherein the processing unit is arranged to operably send a third request to request the file system when a second event of the first UI control has occurred, so as to obtain previously calculated release estimates for accumulated inspection sets from the file system; and direct the display unit to display the previously calculated release estimates on the second GUI.

16. The apparatus of claim 15, wherein the processing unit is arranged to operably direct the display unit to display a warning message indicating that the previously calculated release estimates is no or less informative on the second GUI when a distorted extent of the previously calculated release estimates has exceeded a threshold.

17. The apparatus of claim 9, wherein any of the accumulated inspection sets, except for the first one, includes the first COW snapshot IDs more than or consistent with that of the prior one.

18. The apparatus of claim 9, wherein the processing unit is arranged to operably and periodically request the file system to report the current estimation progress.

19. The apparatus of claim 17, wherein the processing unit is arranged to operably direct the display unit to update the content of a message box of the first GUI according to the current estimation progress received from the files system.

20. The apparatus of claim 18, wherein the current estimation progress comprises how many bytes have been scanned and how many bytes of scanned objects can be released.
